(19) United States
(12) Patent Application Publication
(10) Pub. No.: US 2011/0174774 A1
(43) Pub. Date: Jul. 21, 2011

(54) METHOD OF DESCUMMING PATTERNED PHOTORESIST

(76) Inventors: Ying-Chih Lin, Tainan City (TW); Pei-Yu Chou, Tainan County (TW); Jiunn-Hsiung Liao, Tainan Hsien (TW); Chih-Wen Feng, Tainan County (TW); Feng-Yi Chang, Chiayi County (TW); Shang-Yuan Tsai, Kaohsiung City (TW)

(21) Appl. No.: 12/690,935

(22) Filed: Jan. 21, 2010

(51) Int. Cl. B44C 1/22

(52) U.S. Cl. 216/41

(57) ABSTRACT

A method of descumming a patterned photoresist is provided. First a material layer to be etched is provided. The material layer is covered by a patterned photoresist. Then a descum process is preformed to descum the edge of the patterned photoresist by nitrogen. Finally, the descummed patterned photoresist is used as a mask for etching the material layer.

### BACKGROUND OF THE INVENTION

1. Field of the Invention

The present invention relates to a method of descumming a patterned photoresist, more particularly to a method using a special gas to descum the patterned photoresist.

2. Description of the Prior Art

The photolithographic process is the most important step in semiconductor fabrication. It transfers the layout of a designed integrated circuit onto a semiconductor wafer.

As the complexity and the integration of semiconductor circuits increases, the size of the circuit design pattern on the photoresist layer decreases. However, the critical dimensions of the pattern on the photoresist layer are limited by the resolution limit of the optical exposure tool. Especially, when the critical dimensions of the semiconductor circuits goes below than 28 nanometers, the resolution of the optical exposure tool is not small enough to support the process. Therefore, to reduce the critical dimension, the optical exposure tool itself must be changed with a new light source. The material used in the photoresist must be changed as well when the light source of the optical exposure tool is changed, and the cost increases dramatically. Furthermore, after the photoresist is patterned, there are some incorrectly unexposed photoresist remains, ie. the photoresist which is not exposed due to some exposure problem will not be cleaned by the development solution. The incorrectly unexposed photoresist leads to the deformation of the patterned photoresist.

To solve the problem, a descumming process is added between the development process and the etching process. Generally, the descumming process is performed by using the plasma to trim the patterned photoresist. If the patterned photoresist is a gate pattern, the descumming process is primarily to remove a predetermined thickness of the patterned photoresist, and to make the patterned photoresist to have a smaller critical dimension. If the patterned photoresist a contact hole pattern, the descumming process is mainly used for removing the unwanted photoresist which is incorrectly unexposed. The descumming gas is usually comprises oxygen. Although the descumming process can reduce the critical dimension or remove the unwanted photoresist without changing the exposure tool, the oxygen-containing plasma has a high etching rate to the patterned photoresist which may result in roughness of the sidewall of the patterned photoresist, and unevenness in the critical dimensions of the patterned photoresist. Furthermore, the high etching rate of the oxygen-containing plasma will cause the thickness of the patterned photoresist to be not enough to protect a material layer under the patterned photoresist during the etching process. Therefore, the original pattern on the photomask cannot be transferred onto the material layer because the patterned photoresist is deformed after the descumming process. Moreover, in the traditional process, a deposition gas used during the etching process is performed to adjust the final critical dimension of the patterned photoresist. But the deposition gas easily clogs on the sidewall of the patterned photoresist, and also causes the deformation of the patterned photoresist.

### SUMMARY OF THE INVENTION

It is therefore one objective of the present invention to provide a method of descumming a patterned photoresist layer to remove the incorrectly unexposed photoresist layer, and guarantee the descummed patterned photoresist layer has enough thickness to serve as an etching mask.

According to a preferred embodiment of the present invention, a method of descumming a patterned photoresist includes, providing a material layer to be etched covered by a patterned photoresist. Then, a descumming process is performed by using nitrogen to trim the edge of the patterned photoresist. Finally, the material layer is etched by taking the descumming patterned photoresist as a mask. The descumming process is performed in a plasma reacting chamber. The pressure in the plasma reacting chamber is 1 to 100 milli torr, and the activated high frequency power of the plasma reacting chamber is 50 to 1000 watts, and the bias high frequency power of the plasma reacting chamber is 20 to 500 watts. The nitrogen flows toward the front side of the wafer, and the ratio of the flow rate of the nitrogen above the center of the front side to the flow rate of the nitrogen above an edge of the front side is 30:70. The ratio of the pressure of the backside gas toward the center of the back side to the pressure of the backside gas toward an edge of the back side is 30:40. The operating time of the descumming process is 5 to 12 seconds.

The feature of the present invention is that the descumming process is performed merely by using the nitrogen to remove a predetermined thickness of the patterned photoresist layer because the etching rate of the plasma nitrogen is not greater than 30 angstrom/second which is much slow than that of the oxygen-containing plasma. Therefore, the descumming patterned photoresist layer can still have an adequate thickness to serve as an etching mask.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 7 are diagrams schematically depicting a method of descumming a patterned photoresist layer.

FIG. 8 depicts a structure of a patterned top photoresist layer after the conventional descumming process.

FIG. 9 depicts an incomplete contact hole schematically.

### DETAILED DESCRIPTION

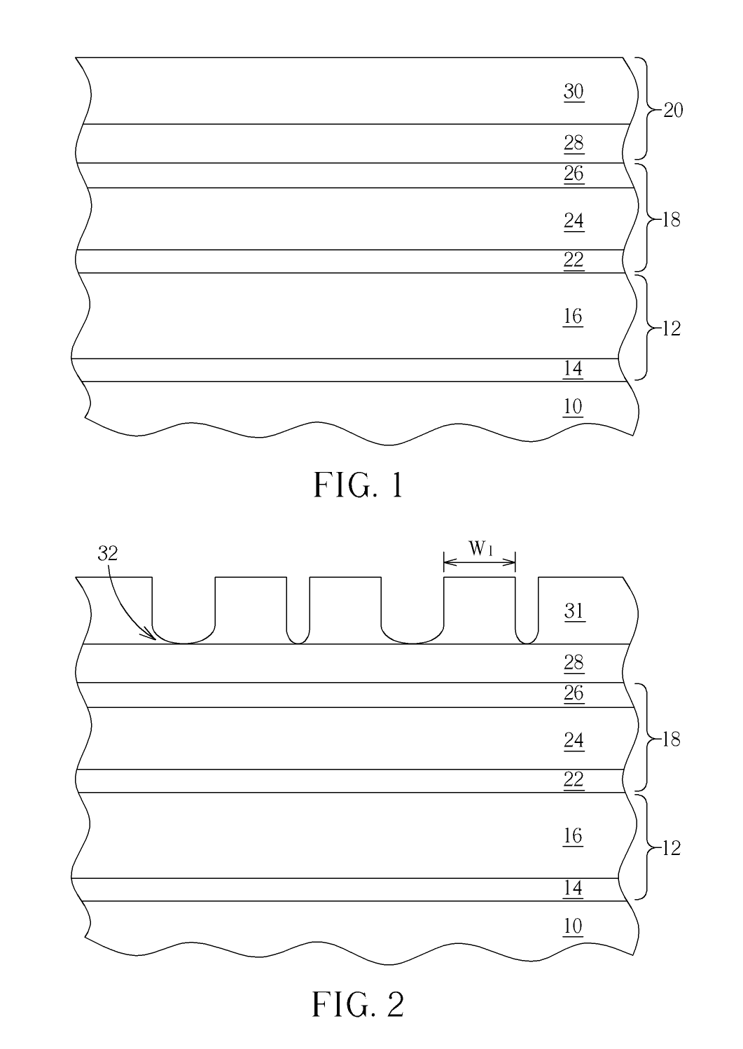

FIG. 1 to FIG. 7 are diagrams schematically depicting a method of descumming a patterned photoresist layer. As shown in FIG. 1, a substrate such as a wafer 10 is provided. A material layer 12 to be etched such as an etching stop layer 14 and a dielectric layer 16 is positioned on the material layer 12. The material layer 12 can be a single structure or multiple structures. Then, a hard mask layer 18 and a photoresist layer 20 are positioned on the dielectric layer 16. The hard mask layer 18 may include a silicon oxide layer 22, a silicon oxynitride layer 24 and an APF film 26 (trade name, available from Applied Materials, Inc. of Santa Clara, Calif.), but not limited to them, as other materials such as silicon nitride or silicon carbon can be used as the hard mask layer 18. The photoresist layer 20 may include a top photoresist layer 30 and an anti-reflective coating (BARC) 28. Later, an exposure and a development process are performed to transfer a pattern from a photo mask (not shown) onto the top photoresist layer 30. After that, as shown in FIG. 2, a patterned top photoresist layer 31 is formed. In the present invention the pattern on the photo mask is for making numerous patterned contact holes, but not limited to it. The pattern on the photo mask can be a gate, a single damascene structure, a dual damascene structure, a shallow trench or other patterns.

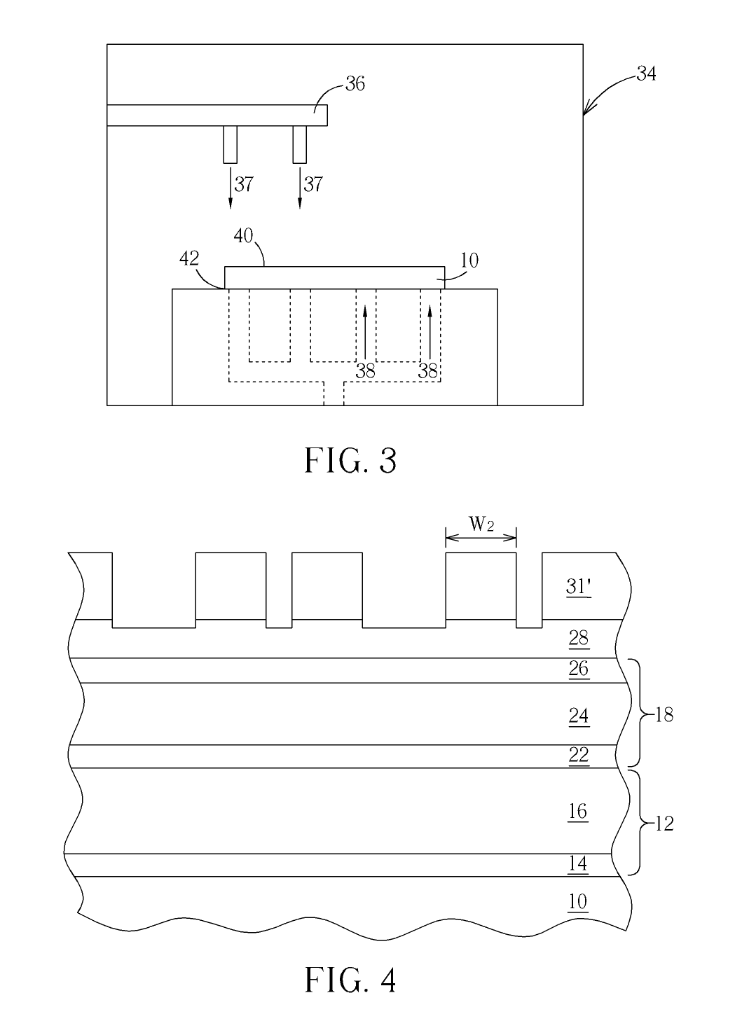

As shown in FIG. 2, after the exposure and the development process are performed, there is still a photoresist protrusion 32 remaining. The photoresist protrusion 32 is the part of the top photoresist layer 30 which is incorrectly unexposed. In other words, the photoresist protrusion 32 is the part of the top photoresist layer 30 which is unexposed due to some fabrication errors. Therefore, the patterned top photoresist layer 31 is deformed, and the contact hole formed afterwards will have an incorrect shape. As a result, a descumming process is needed to remove the photoresist protrusion 32. The descumming process is performed in an exclusive nitrogen-containing atmosphere. For example, as shown in FIG. 3, the wafer 10 is sent into a plasma reacting chamber 34. The pressure of the plasma reacting chamber 34 is 1 to 100 milli torr, and preferably is 5 to 20 milli torr. The activated high frequency power of the plasma reacting chamber is 50 to 1000 watts, preferably is 200 to 400 watts, and the bias high frequency power of the reacting chamber is 20 to 500 milli torr, preferably is 100 to 300 watts. The nitrogen 37 is sent into the plasma reacting chamber 34 from the inlet of a tube 36 with a flow rate of 300 sccm. When the nitrogen 37 goes in to the plasma reacting chamber 34, the nitrogen 37 flows toward a front side 40 of the wafer 10, and the ratio of the flow rate of the nitrogen 37 above the center of the front side 40 to the flow rate of the nitrogen 37 above an edge of the front side 40 is 30:70. A backside gas 38 flows toward a back side 42 of the wafer 10, and the ratio of the pressure of the backside gas 38 toward the center of the back side 42 to the pressure of the backside gas 38 toward an edge of the back side 42 is 30:40. The descumming process is performed at the above mention condition for 5 to 12 seconds. The etching rate of the nitrogen plasma to the patterned top photoresist layer 31 is not greater than 30 angstrom/second. Preferably, the etching rate of the nitrogen plasma is 30 angstrom/second. As shown in FIG. 4, the photoresist protrusion 32 is removed, and part of the sidewall of the patterned top photoresist layer 31 is removed as well to form a patterned top photoresist layer 31′. Please refer to FIG. 2 and FIG. 4, a width of the patterned top photoresist layer 31 is W1, and a width of the patterned top photoresist layer 31′ is W2. Obviously, the width of the patterned top photoresist layer 31 is reduced. Furthermore, the height of the patterned top photoresist layer 31 is also decreased. Moreover, part of the BARC 28 is removed during the descumming process to ensure the photoresist protrusion 32 is cleaned entirely.

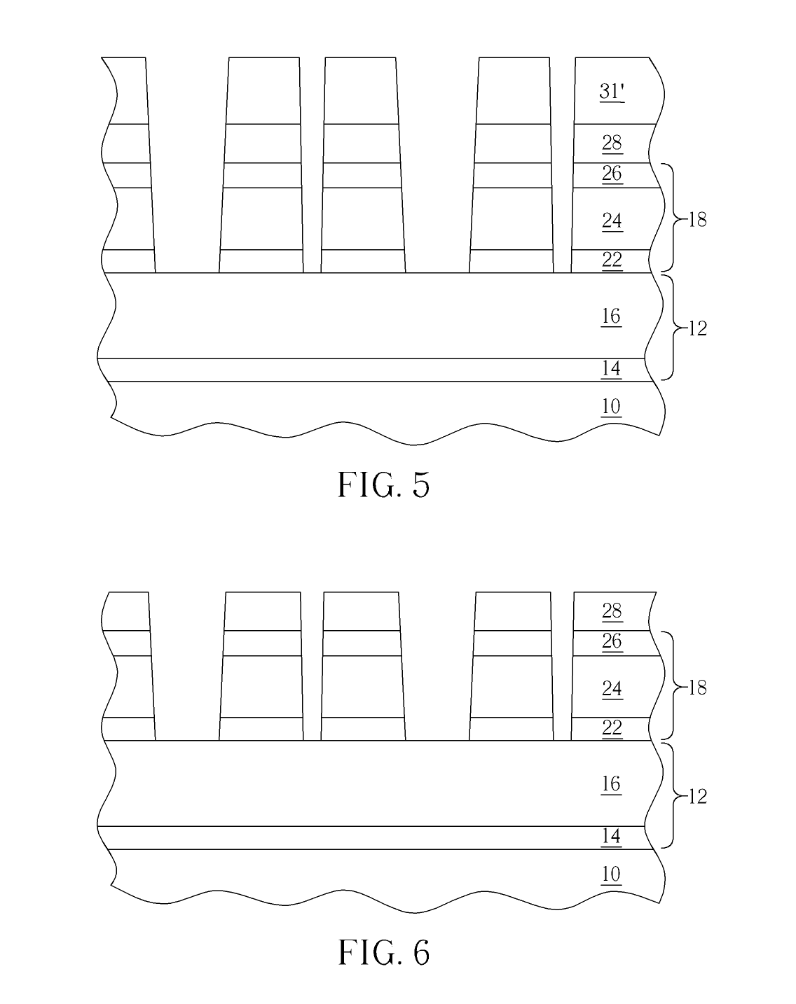

As shown in FIG. 5, the BARC 28 and the hard mask layer 18 are etched by taking the patterned top photoresist layer 31′ as a mask. Then, the pattern on the patterned top photoresist layer 31′ is transferred onto the BARC 28 and the hard mask layer 18. During the etching process, a deposition gas and an etchant are sent into the plasma reacting chamber simultaneously. When the etchant is etching the BARC 28 and the hard mask layer 18, the deposition gas will form polymers attaching on the sidewall of the BARC 28 and the hard mask layer 18. In this way, the critical dimension of the openings on the BARC 28 and the hard mask layer 18 will be reduced. For example, if the critical dimension of the patterned top photoresist layer 31′ is 58 nanometers, by using the deposition gas during etching the BARC 28 and the hard mask layer 18, the critical dimension of the BARC 28 and the hard mask layer 18 can be reduced to about 30 nanometers.

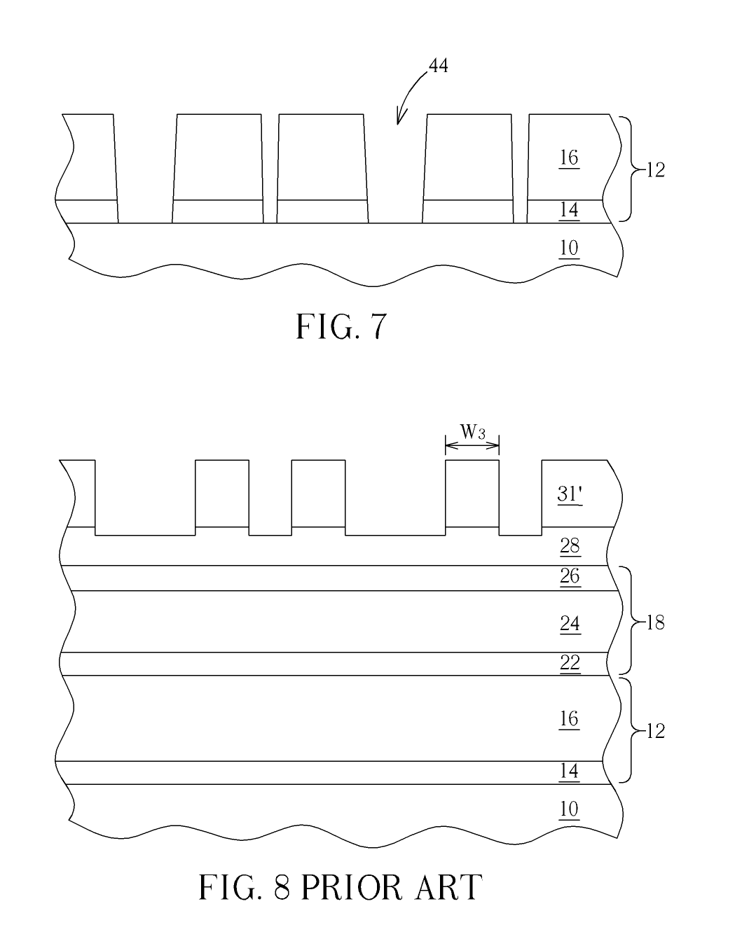

As shown in FIG. 6, the patterned top photoresist layer 31′ is removed. Then, the dielectric layer 16 is etched first, and the etching stop layer 14 is etched later by taking the BARC 28 and the hard mask layer 18 as an etching mask to form a contact hole 44. As shown in FIG. 7, the BARC 28 and the hard mask layer 18 are removed. The aforesaid descumming process can be performed in situ with the process of etching the BARC 28 and the hard mask layer 18, and the process of etching dielectric layer 16 and the etching stop layer 14, but not limited to this method. According to different requirements, the descumming process can be performed ex situ with the etching process.

Although the descumming process is performed by using merely nitrogen as an etchant, however, methane, the mixture of methane and nitrogen or hydrogen can be utilized as an etchant in the descumming process.

In the conventional process, the descumming process is performed by using the mixture of oxygen and carbon monoxide plasma. Please refer to FIG. 3. The convention descumming process can be performed in the same chamber mentioned in FIG. 3. When using the oxygen-containing plasma, the pressure of the plasma reacting chamber 34 is 10 milli torr. The activated high frequency power of the plasma reacting chamber 34 is 500 watts, and the bias high frequency power of the reacting chamber 34 is 120 watts. The oxygen and carbon monoxide are sent into the plasma reacting chamber 34 from the inlet of a tube 36 with a flow rate ratio of 150:40. When the mixture of the oxygen and carbon monoxide having the flow rate ratio of 150:40 goes in to the plasma reacting chamber, the mixture gas flows toward a front side of the wafer 10, and the ratio of the flow rate of the mixture above the center of the front side 40 to the flow rate of the mixture above an edge of the front side 40 is 90:10. A backside gas flows toward the backside 42 of the wafer 10, and the ratio of the pressure of the backside gas 42 toward the center of the back side 42 to the pressure of the backside gas 42 toward an edge of the back side 42 is 30:40. The operating time of the conventional descumming process is about 4 seconds, and the etching rate of the oxygen-containing plasma for etching the patterned top photoresist layer is 70 to 80 angstrom/second.

Compared to the nitrogen plasma used in the present invention, the oxygen-containing plasma used in the conventional process has a higher etching rate to the patterned top photoresist layer. Therefore, after using the conventional method to descum the patterned top photoresist layer, the patterned top photoresist layer will be deformed due to the high etching rate. FIG. 8 depicts a structure of a patterned top photoresist layer after the conventional descumming process. Because the oxygen-containing plasma has a high etching rate for the patterned top photoresist layer, much of the patterned top photoresist layer will be consumed after the descumming process. It can be seen in FIG. 8, the horizontal and the vertical direction of the patterned top photoresist layer 31′ are etched a lot. Compared to FIG. 4, the thickness and the width W3 of the patterned top photoresist layer 31′ in FIG. 8 are much smaller than the thickness and the width W2 of the patterned top photoresist layer 31′ in FIG. 4. Therefore, the critical dimension of the opening of the patterned top photoresist layer 31′ in FIG. 8 is much greater than that of the patterned top photoresist layer 31′ in FIG. 4. Furthermore, since thickness and the width are reduced, during the etching process, the patterned top photoresist layer 31′ is also consumed in the etching process, and the remaining patterned top photoresist layer 31′ cannot protect the BARC 28 and the hard mask 18 entirely. As a result, a deformed pattern may be transferred onto the material layer 12 in the end.

Moreover, the width W3 in FIG. 8 is much smaller than the width W2 in FIG. 4. Therefore, to adjust the opening of the patterned top photoresist layer 31′ to a demanded critical dimension, more deposition gas is needed in the conventional process. However, the polymer formed by the deposition gas clogs on the sidewall of the patterned top photoresist layer 31′ easily. Sometimes the opening of the patterned top photoresist layer 31′ may be blocked by the polymer due to the increased deposition gas. As a result, the structure of the contact hole which should be formed in the dielectric layer 16 is not formed completely.

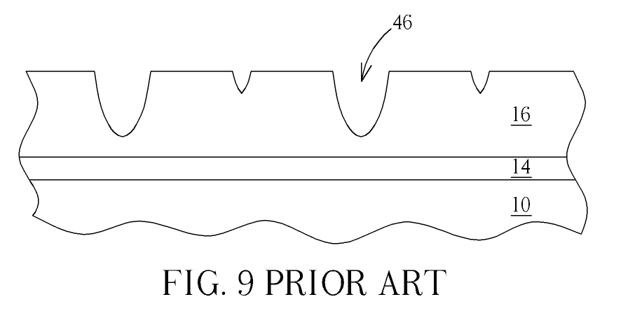

FIG. 9 depicts an incomplete contact hole schematically. Please refer to both FIG. 7 and FIG. 9, as shown in FIG. 9, the bottom of the contact hole 46 is incomplete. As shown in FIG. 7, a complete contact hole 44 should expose the wafer 10. Therefore, the contact hole 46 in FIG. 9 will lead to an open circuit. Moreover, as mentioned above, the oxygen-containing plasma has a high etching rate, to prevent the patterned top photoresist layer from being over etched by the oxygen-containing plasma, the operating time of the oxygen-containing plasma in shorter than 4 seconds. However, the short operating time causes instability of the process and leads to the unevenness of the patterned top photoresist layer.

The present invention features that the descumming process is performed in an exclusive nitrogen-containing environment. Because the nitrogen has lower etching rate to the patterned top photoresist layer compared to the oxygen-containing plasma, the remaining patterned top photoresist layer is thick enough to protect the hard mask layer during the etching process. Furthermore, only a small amount of deposition gas is needed to adjust the critical dimension of the opening of the patterned top photoresist layer, and the contact hole can be formed completely. Moreover, the operating time of the present invention is long enough to perform a stable descumming process, and the uniformity of the patterned top photoresist layer is better.

Those skilled in the art will readily observe that numerous modifications and alterations of the device and method may be made while retaining the teachings of the invention.

What is claimed is:

1. A method of descumming a patterned photoresist, comprising:
providing a material layer to be etched covered by a patterned photoresist;
performing a descumming process by utilizing nitrogen to trim an edge of the patterned photoresist; and
etching the material layer by taking the patterned photoresist as a mask after the descumming process.

2. The method of descumming a patterned photoresist of claim 1, wherein the descumming process is performed in a plasma reacting chamber.

3. The method of descumming a patterned photoresist of claim 2, wherein when the descumming process is performed, the pressure in the plasma reacting chamber is 1 to 1000 milli torr.

4. The method of descumming a patterned photoresist of claim 2, wherein the material layer is positioned at a front side of a wafer.

5. The method of descumming a patterned photoresist of claim 4, wherein when the descumming process is performed, the nitrogen flows toward the front side of the wafer, and the ratio of the flow rate of the nitrogen above the center of the front side to the flow rate of the nitrogen above an edge of the front side is 30:70.

6. The method of descumming a patterned photoresist of claim 2, wherein the activated high frequency power of the plasma reacting chamber is 50 to 1000 watts, and the bias high frequency power of the plasma reacting chamber is 20 to 500 watts.

7. The method of descumming a patterned photoresist of claim 2, wherein when the descumming process is performed, a backside gas flows toward a back side of the wafer, and the ratio of the pressure of the backside gas toward the center of the back side to the pressure of the backside gas toward an edge of the backside is 30:40.

8. The method of descumming a patterned photoresist of claim 1, wherein the operating time of the descumming process is 5 to 12 seconds.

9. The method of descumming a patterned photoresist of claim 1, wherein the etching rate of the nitrogen to trim the patterned photoresist is not greater than 30 angstrom/second.

10. The method of descumming a patterned photoresist of claim 1, wherein the patterned photoresist has a protrusion and the descumming process further comprises trimming the protrusion.

11. A method of descumming a patterned photoresist, comprising:
providing a material layer to be etched covered by a patterned photoresist;
performing a descumming process by utilizing a gas having an etching rate below 30 angstrom/second to trim an edge of the patterned photoresist; and
etching the material layer by taking the patterned photoresist as a mask after the descumming process.

12. The method of descumming a patterned photoresist of claim 11, wherein the gas comprises nitrogen.

13. The method of descumming a patterned photoresist of claim 11, wherein the gas comprises methane.

14. The method of descumming a patterned photoresist of claim 11, wherein the operating time of the descumming process is 5 to 12 seconds.

15. The method of descumming a patterned photoresist of claim 11, wherein the descumming process is performed in a plasma reacting chamber.

16. The method of descumming a patterned photoresist of claim 15, wherein when the descumming process is performed, the pressure in the plasma reacting chamber is 1 to 100 milli torr.

17. The method of descumming a patterned photoresist of claim 15, wherein the activated high frequency power of the plasma reacting chamber is 50 to 1000 watts, and the bias high frequency power of the plasma reacting chamber is 20 to 500 watts.

18. The method of descumming a patterned photoresist of claim 15, wherein the material layer is positioned at the front side of a wafer.

19. The method of descumming a patterned photoresist of claim 18, wherein when the descumming process is performed, the gas flows toward the front side of the wafer, and the ratio of the flow rate of the gas above the center of the front side to the flow rate of the gas above an edge of the front side is 30:70.

20. The method of descumming a patterned photoresist of claim 15, wherein when the descumming process is performed, a backside gas flows toward the back side of the wafer, and the ratio of the pressure of the backside gas toward the center of the back side to the pressure of the backside gas toward an edge of the back side is 30:40.
